(19) United States
(12) Patent Application Publication
(10) Pub. No.: US 2015/0186663 A1
(43) Pub. Date: Jul. 2, 2015

(54) SELECTABLE DISPLAY OF DATA ON A PAYMENT DEVICE

(71) Applicant: VISA INTERNATIONAL SERVICE ASSOCIATION, San Francisco, CA (US)

(72) Inventors: Julian Schmidt, Foster City, CA (US); Kenneth Sippola, Foster City, CA (US); Dori Skelding, Foster City, CA (US)

(21) Appl. No.: 14/587,310

(22) Filed: Dec. 31, 2014

Related U.S. Application Data
(60) Provisional application No. 61/922,459, filed on Dec. 31, 2013.

(51) Int. Cl. G06F 21/62; G06K 19/077; G10L 15/22; G06K 9/00; G10L 17/24; G06K 19/07; G06F 3/041

(52) U.S. Cl. CPC G06F 21/62; G06K 19/0718; G06K 19/07707; G06F 3/041; G06K 9/00087; G10L 17/24; G10L 15/22; G10L 2015/223

(57) ABSTRACT

The described payment device includes a display and an input device such that when the input device is activated, some or all of the sensitive information on a payment device is displayed for a period of time. The input can be a variety of actions, from pressing an input to inputting a code of inputs. As a result, sensitive data is better hidden from undesired viewers of the sensitive data.

### CROSS-REFERENCE TO RELATED APPLICATIONS

This application claims the benefit of, and priority to, U.S. Provisional Patent Application Ser. No. 61/922,459 titled “Selectable Display Of Data On A Payment Device,” filed Dec. 31, 2013, the entire content of which is incorporated herein by reference.

### BACKGROUND

Present payment devices such as debit cards and credit cards have sensitive information on their faces. It is not uncommon for payment devices to list an account number, an account holder, an issuing bank, a security code and an expiration date on the payment device. Without much effort, someone could gather such information by merely observing a card for a brief period of time. With security of such sensitive information becoming more and more important, efforts have been made to make payment devices more secure.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

The described payment device includes a display and an input device such that when the input device is activated, some or all of the sensitive information on a payment device is displayed for a period of time otherwise the display may be blank. The input can be a variety of actions, from pressing an input to inputting a code of inputs. As a result, sensitive data is better concealed from unwanted viewers of the sensitive data.

### BRIEF DESCRIPTION OF THE DRAWINGS

The invention may be better understood by reference to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1a is a view of a payment device where the input device has not been actuated;

FIG. 1b is a view of a payment device where the input device is being actuated;

FIG. 1c is a view of a payment device where the input device has been actuated;

FIG. 2a-2c are views of the payment device with a bottom layer, an inner layer and top layer displayed separately;

FIG. 3 is a view of a sample circuit design of the payment device with an input device;

FIG. 4 is a view of a sample circuit design of the payment device with alternate input devices;

FIG. 5a-5e are views of a payment device where the sensitive information is displayed in a sequential manner if the input device is actuated;

FIG. 6a-6c are views of a payment device where a plurality of sensitive information is displayed if the input device is actuated;

FIG. 7a-7c are views of a payment device where one piece of a plurality of sensitive information is displayed if the input device is actuated;

FIG. 8a-8c are views of a payment device where one piece of a plurality of sensitive information is displayed if the input device is actuated;

FIG. 9a-9c are additional views of a payment device where one piece of a plurality of sensitive information is displayed if the input device is actuated;

FIG. 10a-10c are views of a payment device where a portion of sensitive information is displayed in an eye catching manner if the input device is actuated; and

FIG. 11 are views of a payment device including a voice activated input device, an image capturing input device and a fingerprint reader.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### DESCRIPTION

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description is, therefore, not to be taken in a limiting sense.

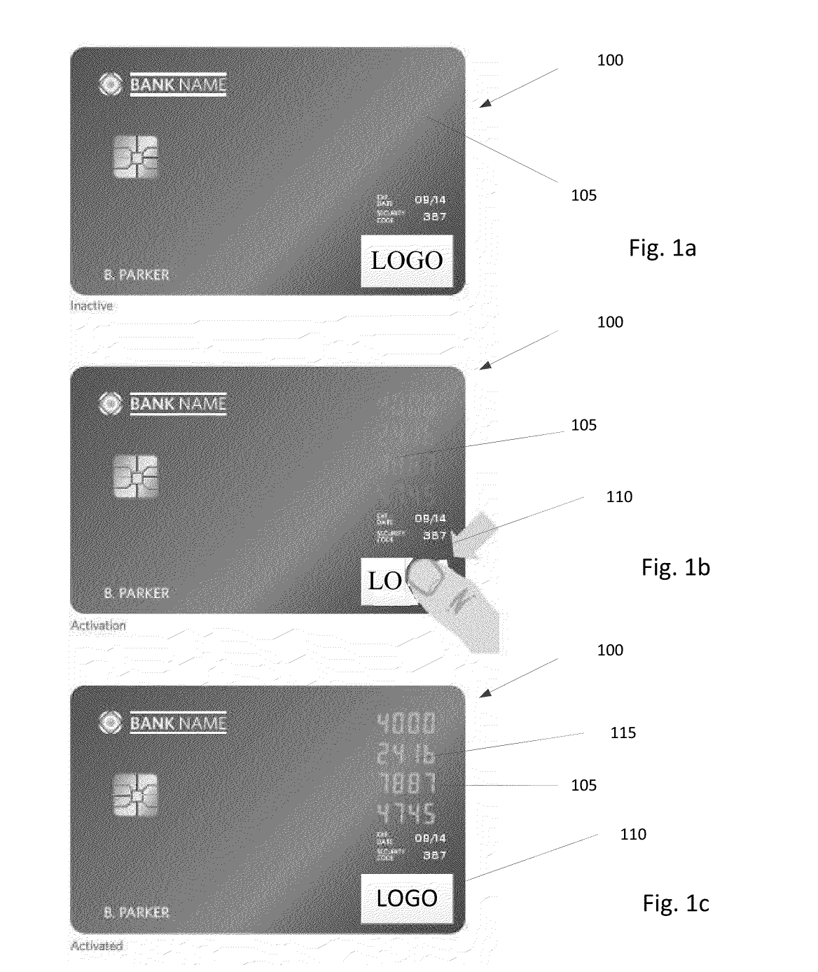

FIGS. 1a-1c illustrate a payment device such as a transactional card (e.g., a credit card or debit card) with a novel display. On traditional payment devices, sensitive information is displayed on the payment device. Some examples of sensitive information include the card number, an account holder name, a credit card validation (ccv) number, a credit verification value, an expiration date, etc. In the hands of someone nefarious, the potentially sensitive information may be used to attempt to make fraudulent purchases or even steal the identity of the account holder. By adding a display that is most often off but can be actuated by a user of the payment device, the sensitive information is safely concealed, resulting in less fraud.

More specifically, FIG. 1a illustrates the payment device 100 with a display 105. Unlike conventional payment devices, the payment device 100 does not illustrate all the standard information that is displayed on payment devices, such as payment device holder names, security codes, expiration dates, etc. Instead, the payment device 100 has one or more displays 105 which may display virtually any information that may be relevant to a transaction or to a user. The display 105 may be actuated by selecting to activate an input device 110 which may take on a variety of shapes and forms and may be executed using a variety of methods. As a result, information that may be potentially sensitive 115 may only be displayed when desired. Further, in some cases, the display of information may be subject to security checks before the information is displayed as will be further explained.

Referring to FIG. 1a, a payment device 100 in the form of a card may be illustrated. As mentioned, the potentially sensitive information 115 of a card number is not displayed on the front of the payment device 100 as would be expected. While it is not immediately visible, a display 105 may be part of the payment device 100 along with an input device 110.

Referring to FIG. 1 b, a user may select to activate an input device 110 on the payment device 100. As will be further explained, the input device 110 may take a variety of shapes and forms and may be activated in a variety of manners. In FIG. 1 b, the input device 110 may be a touch sensitive device and may be actuated by touching the input device 110. The input device 110 may be made to be noticeable or may be disguised as in FIG. 1b where the input device 110 is hidden beneath a card issuer logo which may only be known to the account holder or other authorized owner.

In FIG. 1c, if the input to the input device 110 is determined to acceptable, the sensitive information 115 may be displayed on the payment device 100 on the display 105. As will be further described, the acceptable input may depend in the input device, the desires of the user and the desires of the issuing bank. Further, while the information displayed is described as being sensitive, it may be any data as desired by the payment device issuer or the user. For example, if desired, the display may even display advertisements and/or store specials depending on the locale of the user, what the user has recently searched on a related computing device, messages from a nearby vendor, balances on the account or accounts related to holder of the payment device, user notes, etc. Further, the user may even communicate messages such as reminders to be displayed on display 105 of the payment device 100.

In regard to form, the payment device 100 may take on a variety of shapes and forms. In some embodiments, the payment device 100 is a transactional card such as a debit card or credit card. In other embodiments, the payment device 100 may be a fob on a key chain. In other embodiments, the payment device may be a case for a portable computing device such as a mobile phone. As long as the payment device 100 may be able to communicate securely with a payment accepting device, the form of the payment device may not be especially critical and may be a design choice. For example, many legacy payment devices 100 may have to be read by a magnetic stripe reader and thus, the payment device 100 may have to fit through a magnetic card reader. In other examples, the payment device 100 may communicate through near field communication and the form of the payment device 100 may be virtually any form. Of course, other forms may be possible based on the use of the payment device 100, the type of reader being used, etc.

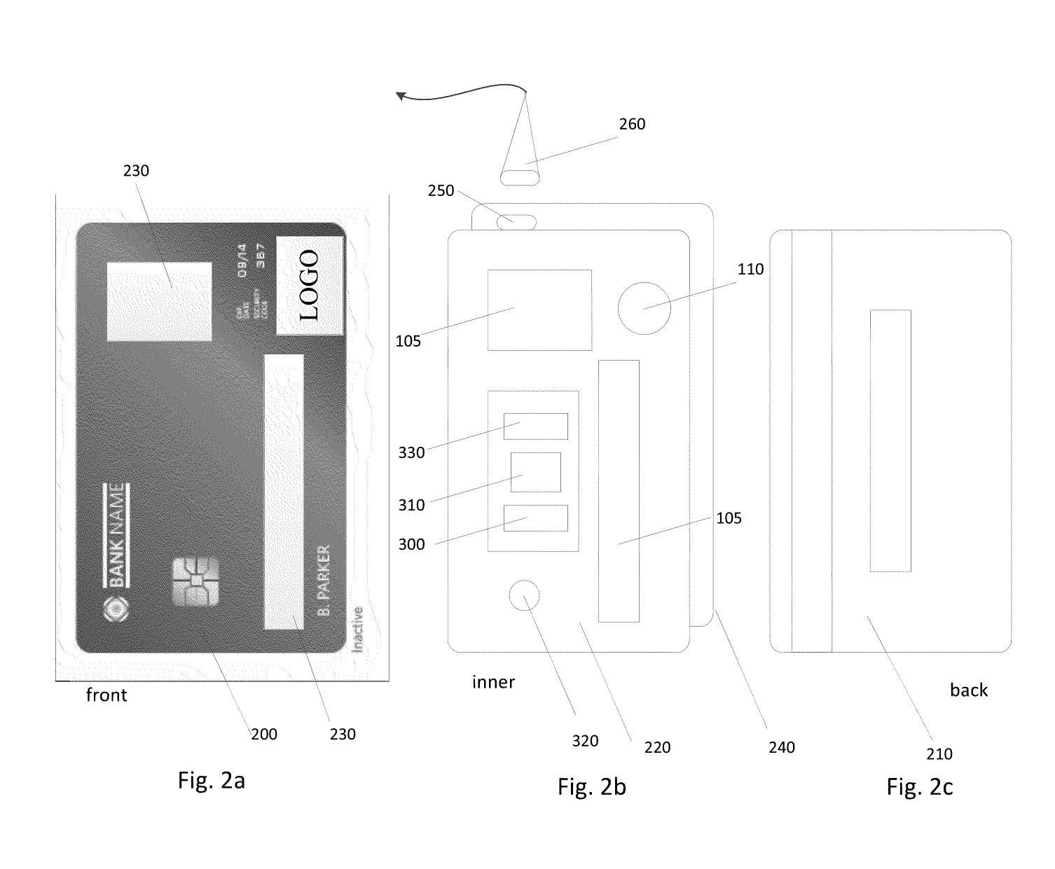

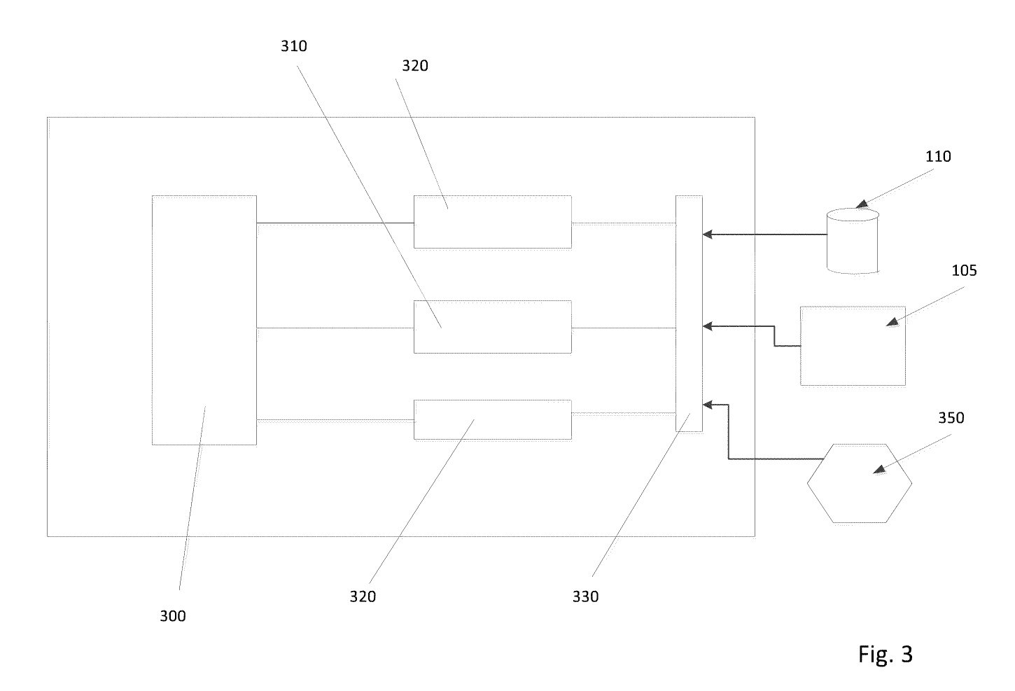

Physically, the payment device 100 may be a card and the card may have a plurality of layers to contain the various elements that make up the payment device 100 as illustrated in FIG. 2. In one embodiment, the payment device 100 may have a substantially flat front surface 200 and a substantially flat back surface 210 opposite the front surface. Logically, in some embodiments, the faces 200, 210 may have some embossments. Further, an inner region 220 may have openings for a processor 300 (FIG. 3), memory 310, power source 320, input/output circuit 330, display 105 and input device 110 that may be part of the payment device 100 as will be explained further.

The substantially flat front surface 200 may include a translucent region 230 through which the display 105 may be viewed. Logically, a user may want to view the display 105. At the same time, the display may have to be protected from the elements. Thus a translucent region of either the top 200 layer and/or bottom layer 210 may be placed over the display 105. It also should be noted that there may be a plurality of displays 105, there may need to be room in the inner layer for each display and there may need to be translucent regions in the top and/or bottom layer to see the displays.

In some embodiments, the majority of a face of the payment device 100 may be a display surface 105 and the display 105 may be touch sensitive. Similar to mobile computing devices, a majority of a payment device face or faces may be a display surface 105 and may display the sensitive data 115 in a variety of places on the payment device 100 in a variety of fonts and sizes which may be more visually attractive than traditional payment devices. In some embodiments, the entire display 105 surface may be touch sensitive and in other embodiments, only regions of the display 105 surface may be touch sensitive. The display 105 may display a logo and issuing bank just like traditional cards while being capable of displaying the other sensitive information 115.

The payment device 100 may also have a stiffness layer. Many circuits, processors, memories, displays, etc., may not be adapted to bend. In fact, many electronic devices break when the devices 100 are bent beyond a threshold. Thus, a stiffening 240 layer of non-flexible material may be added to the payment device 100. Logically, the stiffening layer 240 may be created to not block the display or displays 105. The stiffening layer 240 may be part of the front layer 200, back layer 210, inner region 220 or the entire payment device 100 may be made of a stiff material.

The payment device 100 may have a display 105 that is an organic light emitting diode (OLED) display 105. OLED displays are unique in that some OLEDs are flexible. Thus, an OLED display may allow the payment device 100 to flex if the rest of the equipment in the payment device 100 is capable of bending. In this embodiment, the flexible payment device 100 may be similar to traditional transactional cards (e.g., credit/debit cards) and more familiar to users.

Now referring to FIG. 3, the payment device may have a variety of devices that make up the payment device 100. A processor 300 may be physically configured to enable the input 110 and display 105 along with the other computing elements. The processor 300 may be any processor that fits in the allotted space and can operate using the limited power in the payment device 100 and not generate excessive heat. The processor 300 may be adapted to turn off sections of the processor 300 when those sections are not needed. For example, the processor may turn off the display functions until an input is received from the input device 110 to save power from the power source 320.

The memory 310 may be any appropriate memory that fits in the space and can operate in the power environment of the payment device 100. The memory 310 may be physically configured to store steps to enable the input device 110 and the display 105. The memory 310 may be RAM or ROM, may be transitory or may be persistent depending on the needs of the specific embodiment of the payment device 100. The memory may be physically part of the processor 300 or may be separate.

Similarly, the input/output circuit 330 may communicate signals to and from the processor 300 and it also may be part of the processor 300 or may be a separate device. In addition, the input/output circuit 330 may be required to fit in the space of the payment device 100 and may be required to operate in the power environment of the payment device 100.

The power source 320 may take on a variety of forms and may operate in a variety of ways. The power source 320 may not visible to a human eye as it may be part of the inner layer 220 and may be covered by a non-translucent section of the front 200 or back 210 faces. In some embodiments, it may be visible as users may be curious how the payment device 100 operates. The power source 320 may have to fit in the inner layer 320 and may have to provide sufficient power to operate the processor 300, the memory 310, the display 105, etc.

In some embodiments, the power source 320 may be a battery. In other embodiments, the power source 320 may be a capacitor. In yet another embodiment, a solar cell may be used as part of the power source 320. In some embodiments, the battery, capacitor and solar cell may work together as the power source 320. In some embodiments, the battery may be accessible and replaceable. In other embodiments, the power source 320 may be rechargeable, such as being a lithium based battery or a capacitor that may accept and store a charge. The power source 320 may have interface 250 on the payment device 100 for recharging the power source. In one embodiment, the interface 250 may simply be contacts. In another embodiment, the interface may be a micro-USB port. Of course, other interfaces 250 are possible and are contemplated. Logically, the interface has to fit inside the payment device 100.

A recharging device 260 may be used to recharge the power source 320 through the interface 250. In some embodiments, the recharging device 260 may be in communication with the contacts of the interface 250. In other embodiments, the recharging device 260 may use induction to transfer additional power to the power source 320 through an induction receiver (not shown) in the payment device 100.

Maintaining sufficient power in the power source 320 may be a concern as the display 105 may not operate if there is not enough power. In some embodiments, when power in the power source 320 falls below a threshold, a low power warning may be communicated. In some embodiments, the low power warning may be a message on the display 105. In other embodiments, the low power warning may be an electronic message such as an electronic message on the display 105, an email or a text message to a preset address. Of course, communicating the low power message may also use power so the low power warning may only be communicated if the payment device 100 receives an acceptable communication signal above a threshold such that the message may be quickly communicated without requiring excessive re-sends or repeats. The message may be communicated via a transceiver 350 using, for example, wifi signals, cellular signals, near field communication systems or infrared signals.

The input device 110 may also take on a variety of forms and be actuated in a variety of ways. Logically, the input device 110 may have to fit with the payment device 100 and may be in communication with the input/output circuit 330. In one embodiment, the input device 110 is a heat sensitive region on the payment device 100 and the processor 300 of the payment device 100 determines that the input device 110 has been actuated when the heat sensitive region has warmed beyond a threshold temperature. In another embodiment, the input device 110 is a touch sensitive region on the payment device 100 and the processor 300 of the payment device 100 determines that the input device 110 has been actuated when touching of the touch sensitive region is detected. In some embodiments, the input device 110 may be visible and in other embodiments, the input device 110 may be under a logo, such as from the payment device 100 issuer.

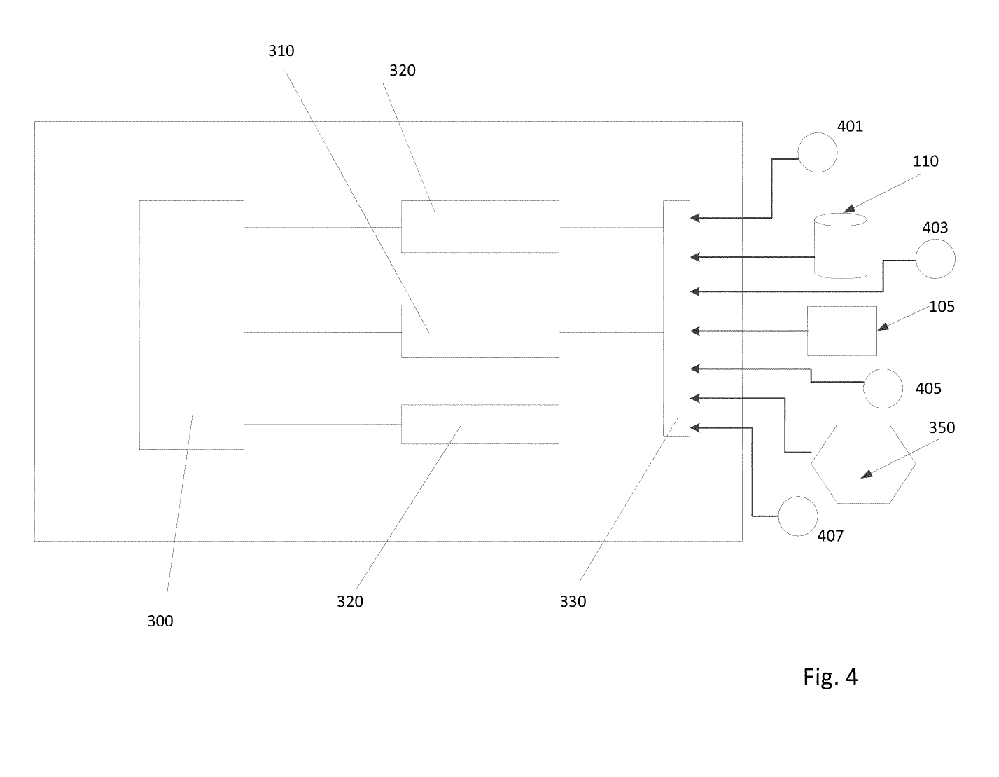

In another embodiment, input device 110 may be a motion sensor 401 (FIG. 4) such as an accelerometer. Such an input device 110 may be actuated by flicking or clicking the payment device 100 which may cause the processor 300 to process a reading from the motion sensor that meets or exceeds a threshold. The threshold may be adjusted by a user as some user may be more active than other users.

In yet another embodiment, the input device 110 may be an electronic signal receiver 350 (FIG. 3) and the input device 110 may be actuated by receiving an actuation signal from a trusted device. For example, the trusted device may be a portable computing device like a mobile phone, may be a payment device reader or an RFID device. In one embodiment, a user may communicate a signal from a mobile telephone to the receiver 350 in the payment device 100 which may be received by the input device 110 and act as the input to actuate the display 105. The processor may process the actuation signal to determine whether the device is trusted. Logically, a message in the actuation signal may be encrypted and may require an exchange of electronic keys to establish trust between the payment device 100 and the trusted computing device. Related, if the actuation signal is received from a non-trusted device more than a threshold number of times during a predetermined period of time, the payment device 100 may reset itself. Resetting may involve the payment device 100 deleting or encrypting some or all of its data stored in memory 310, disabling of the receiver 350, self-destructing, taking other defensive action, and the like. By using an electronic signal as the input, the security of the payment device 100 may be increased.

In another embodiment, the input device 110 may be a fingerprint reader 403 (FIG. 4) adapted to detect fingerprints. The input device 110 may be actuated by receiving a trusted fingerprint on the fingerprint reader. For example, a user may place one or more fingers over the input device 110, which may read a fingerprint for comparison with one or more fingerprints stored in memory 310 of one or more trusted users to look for a match. A fingerprint analysis module (not shown) may be part of the payment device 100 such as in the processor 300 or may be on a remote computing device where the received fingerprint may be communicated to the remote fingerprint analysis module for comparison with one or more trusted fingerprints to look for a match and an approval signal may be received in response by the receiver 350. By using a fingerprint reader, the security of the payment device 100 may be increased. For instance, in response to determining that a user's input fingerprint matches a trusted fingerprint, the payment device 100 may display sensitive data in display 105 and/or may communicate authentication data to a point of sale device indicating that the user is authorized to use the payment device 100 for payment.

The fingerprint analysis module may also enable more than one trusted user to securely use the payment device 100. For example, one or more parents may permit one or more relatives (e.g., children) to use the payment device 100. The payment device 100 or a remote computing device may store one or more fingerprints of each trusted user for comparison with an input fingerprint. A primary trusted user may also place one or more restrictions on secondary trusted users (e.g., spending amount, time period during which spending is authorized, etc.). For example, a parent primary trusted user may limit how much a child secondary trusted user may spend using the payment device 100 (e.g., $200 per month), and when the child may use the payment device 100 (e.g., Friday night between 6-10 PM).

When the payment device 100 is being used to make a payment, the fingerprint analysis module or a remote computing device may determine if a fingerprint received at the fingerprint reader 403 matches a fingerprint stored in memory 310 corresponding to any of the trusted users. If yes, the fingerprint analysis module or a remote computing device may determine if there are any restrictions associated with the trusted user whose fingerprint is being verified. The fingerprint analysis module or a remote computing device may control whether the trusted user may use the payment device 100 for payment. For example, the payment device 100 may communicate authorization data to a point of sale terminal. The authorization data may, for example, indicate that the user is an authorized secondary user of the payment device 100, but has exceeded one or more restrictions, and hence cannot tender the payment device 100 as payment.

In yet another embodiment, the input device 110 may be an image sensor 405 (FIG. 4). The input device 110 may be actuated by receiving an acceptable image which may be set up in advance by an approved user. For example, a user may select a particular image during account enrollment (or at a subsequent time) that is subsequently used to authenticate the user. The pre-selected image may be a picture of: the user (e.g., the user's head, arm, hand, torso, etc.), a government-issued user identification card (e.g., the user's driver's license), the user's device (e.g., smart phone, tablet, computer, and the like) displaying an image, a picture, or some other image or scene. During authentication, the input device 110 may have a camera to capture an image for comparison to the pre-selected image. In another example, a user may upload an image to the payment device 100 via interface 250.

An image analysis module may apply an image analysis algorithm to process the input image looking for a match with the pre-selected image. The image analysis module may be part of the payment device 100 such as in the processor 300 or may be on a remote computing device where the input image may be communicated to the remote image analysis module and an approval signal may be received in response by the receiver 350 based on whether a match is detected. By using an image sensor, the security of the payment device 100 may be increased.

In another embodiment, the input device 110 may be a sound sensor 407 (FIG. 4) such as a microphone. The input device 110 may be actuated by receiving a voice or sound from the user that matches a pre-established sound. For example, a user may provide speech (e.g., one or more words or sounds) during account enrollment (or at some other time) that is used for subsequent authentication of the user. The pre-established sound may be, for example, a recording of the user speaking a preset voice command (e.g., “I approve this purchase,” “I am John Smith,” etc.). In another example, the pre-established sound may be a recording played by a user device (e.g., smartphone, tablet, computer, etc.)

A sound analysis module may apply a sound analysis algorithm (e.g., a voice analysis algorithm) to process input sound looking for a match with the pre-established sound. A sound analysis module may be part of the payment device 100 or may be on a remote computing device where the received sound may be communicated to the remote sound analysis module and an approval signal may be received in response by the receiver 350 based on whether a match is detected. By using a sound sensor, the security of the payment device 100 may be increased.

In yet another embodiment, there may be a plurality of input devices 110. A first input device 110 may actuate a display of first data and a second input device 110 may actuate display of second data. As an example, the first data may be a name, for example, and the second data may be an expiration date. Similarly, a first sequence of inputs to the plurality of input devices 110 may actuate a display of first data and a second sequence of inputs may actuate a display of second data. For example, the input/output circuit 330 or processor 300 may detect actuation of a first input device 110 three times and then actuation of the second input device 110, and, in response thereto, may cause the display 105 to display the account number. The first data may include a ccv, expiration date, card number, user name, and issuer and may exclude the second data and the second data may include a ccv, expiration date, card number, user name and issuer and may exclude the first data.

If the input device 110 is activated, a variety of steps or events might happen. In one embodiment, a portion of the payment device 100 may illuminate such as a logo or the input device 110 itself may illuminate, or any combination may be illuminated. In addition, the display 105 may display the desired sensitive data 115 when the input device 110 is actuated. As mentioned previously, the sensitive data 115 may be virtually any data needed to complete a transaction such as ccv, expiration date, card number, user name, and issuer.

In some embodiments, actuating the input device 110 may cause the sensitive data 115 to be displayed in a rotating manner through the display 105. For example, a single input may cause the account number to be displayed, an additional input may cause the expiration date to be displayed and yet another input may cause the expiration to be displayed.

In yet some more embodiments, the payment device 100 may include a plurality of displays 105 placed in the payment device 100. A single input may cause the sensitive data 115 to appear in any of the displays 105. In yet another embodiment, the input device 110 may be actuated to display the desired sensitive data 115 in a rotating manner through the displays 105. In other embodiments, the sensitive data 115 may be displayed randomly in the various displays 105.

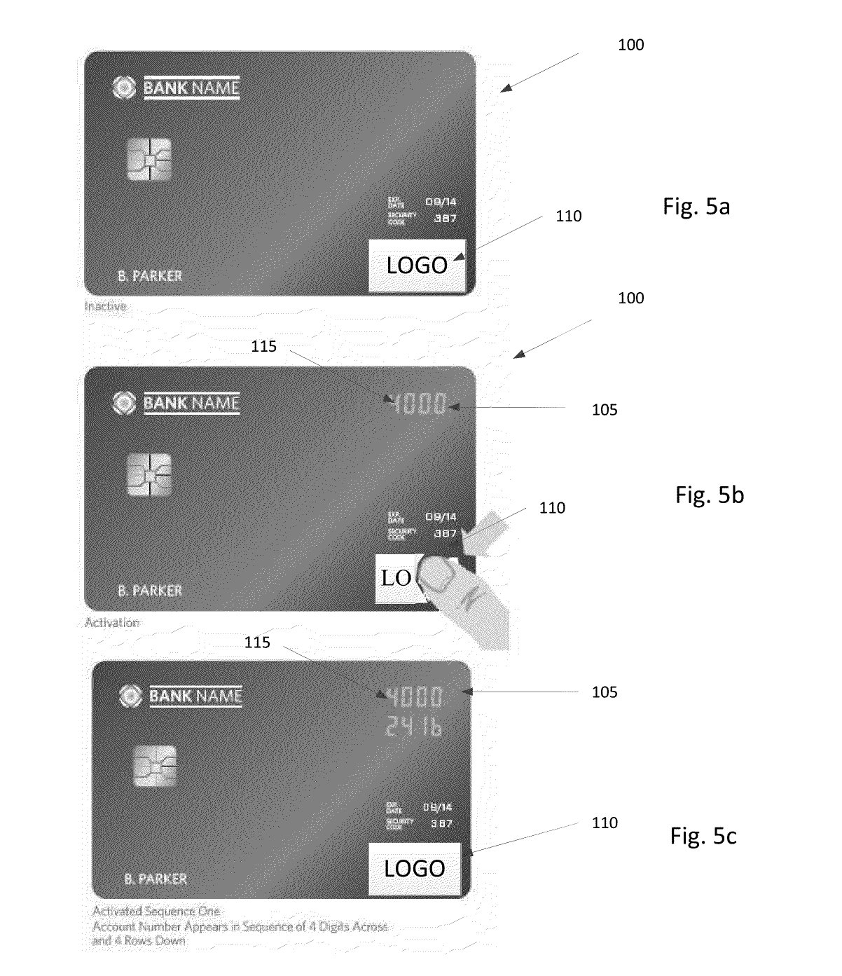

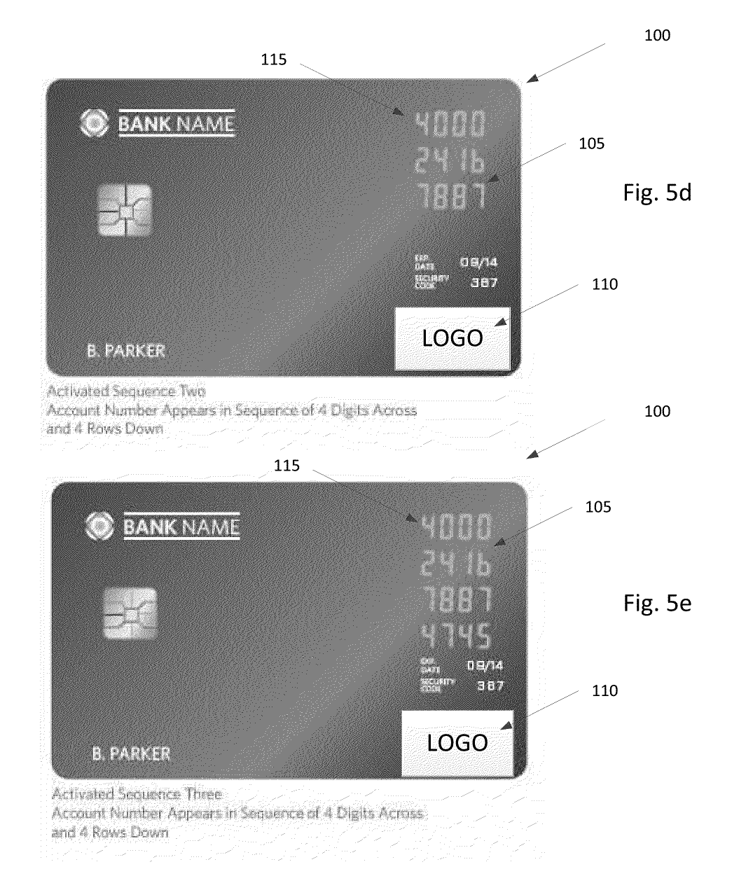

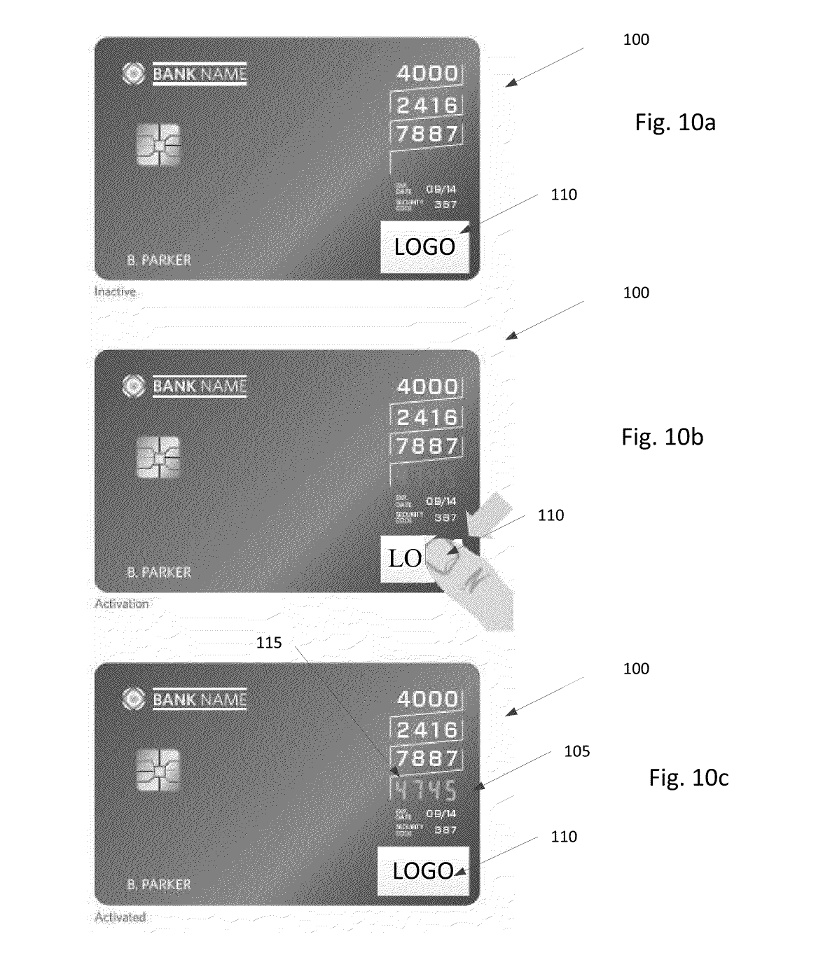

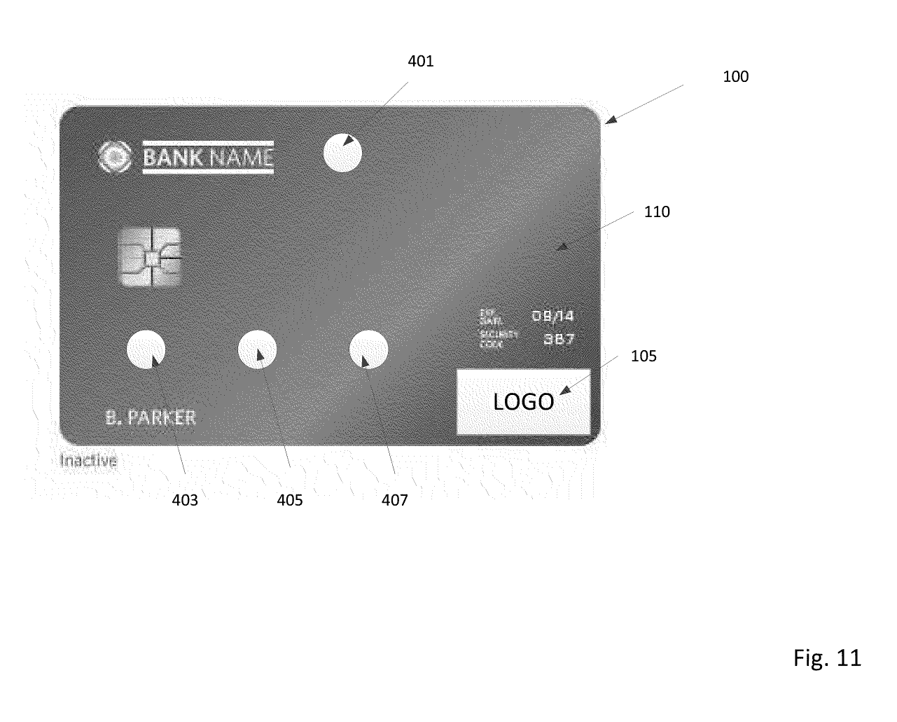

In another embodiment, actuating the input device 110 may display a portion of the sensitive data 115. As illustrated in FIG. 5a-5e, a payment device 100 may display some sensitive data 115 and with each acceptable input, more of the additional sensitive data 115 may be displayed. In another example, each row of four digits of the sensitive data 115 may be displayed in a sequential and eye catching manner. In FIG. 10a-10c, twelve of the sixteen digits of the account may always be displayed and when the input device 110 is actuated, the final four digits of the account number may be displayed in the display 105.

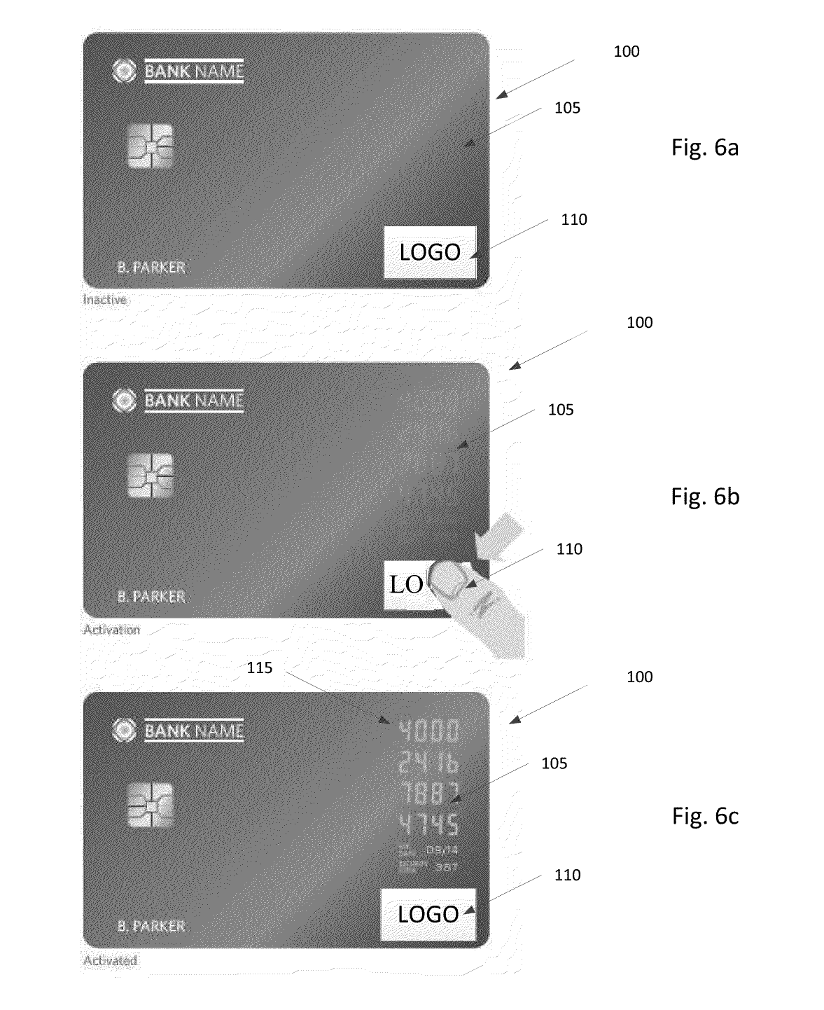

In FIG. 6a-6c, the payment device 100 initially may not display any sensitive data 115. Once an acceptable input is made to the input device 110, a plurality of sensitive information 115 may be displayed. Specifically, in FIG. 6c, the card number, expiration date and security code all are displayed.

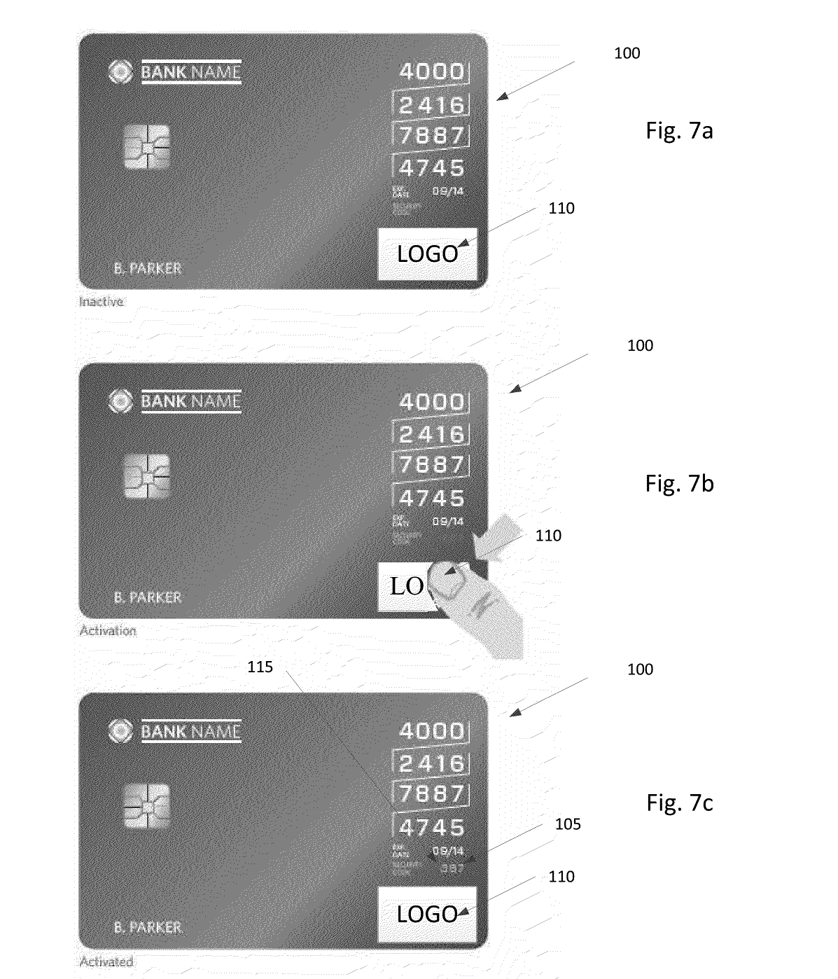

FIG. 7a-7c illustrates a payment device 100 where one piece of a plurality of sensitive information 115 may be displayed if the input device is actuated. Specifically, a security code is only displayed on the display 105 if an acceptable input to the input device 110 is received.

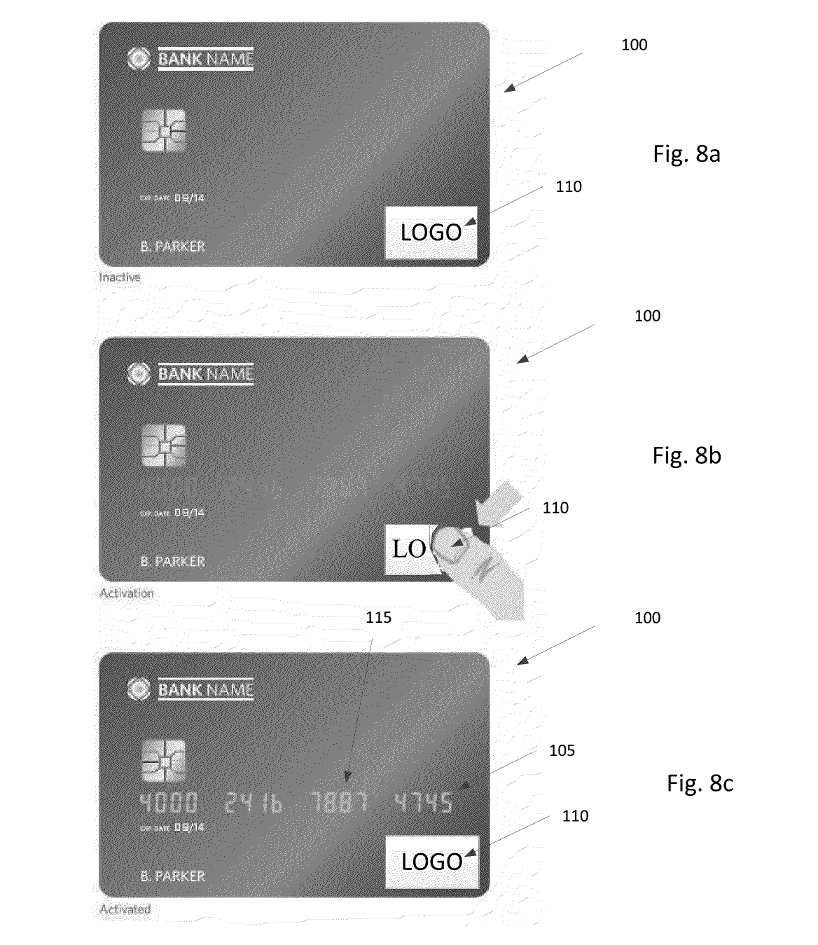

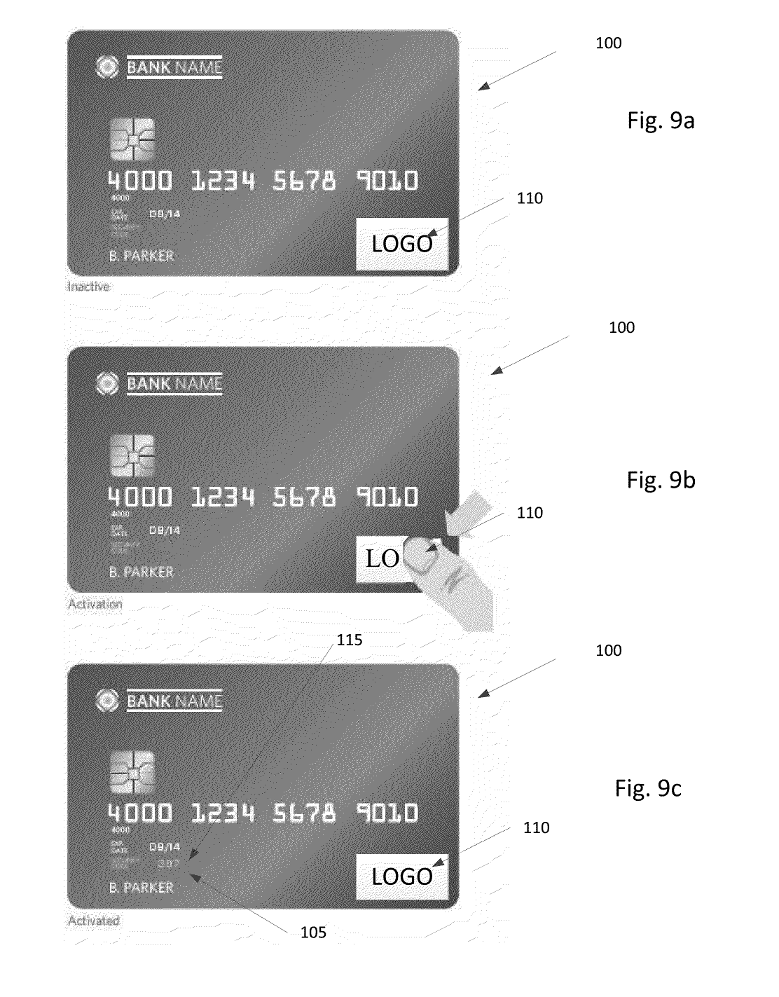

As mentioned previously, the display 105 may be on the payment device 100 in a variety of places. In FIG. 8a-8c, one portion of a plurality of sensitive data 115 may be displayed if the input device is actuated and the display is across the payment device 100. Logically, the display 105 may be placed in a variety of locations on the payment device 100. Similarly, in FIG. 9a-9c, one portion of a plurality of sensitive data 115 may be displayed on the display 105 if the input device 110 is actuated and the display 105 may be small in comparison to the size of the payment device 100.

Logically, the display of sensitive data 115 on the display 105 may only be for a given period of time (e.g., 3 seconds, 15 seconds, 1 minute, etc.). The power source 320 may have a limited life so it may be logical to limit the length of the display. Further, the limited length may make it more difficult for the sensitive data 115 to be stolen. In some embodiments, the length of time for a display 105 to display the sensitive data 115 may have a default value and may be further adjusted by a user.

In further examples, the payment device 100 may only make account information available for reading by an electronic reader terminal (e.g., point of sale terminal) in response to actuation of the input device 110. In an example, the payment device 100 optionally may not include a magnetic stripe and instead the input/output circuit 330 may generate a magnetic field on-demand (e.g., in response to actuation of the input device 110). The magnetic field may vary corresponding to information typically encoded in the magnetic stripe (e.g., track 1/track 2 data of a transactional card) for reading by the reader terminal. In further examples, the payment device 100 may store data on multiple accounts. For example, payment device 100 may store data for multiple transaction accounts, such as two or more credit card accounts and/or two or more debit card accounts, or a combination of one or more credit card accounts and one or more debit card accounts. The user may provide input via the input device 110 to select a particular one of the accounts. For example, the user may press the input device 110 one or more times to scroll through the accounts until the payment device 100 displays the desired account information in display 105. Once displayed, the payment device 100 may emit a magnetic field that varies corresponding to information of the displayed account.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

The payment devices described herein may be general purpose computers that may have, among other elements, a microprocessor (such as from the Intel Corporation, AMD or Motorola); volatile and non-volatile memory; various user input devices; and an electronic display. It is contemplated that any suitable operating system may be used for the present invention.

The payment devices described herein optionally may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, the systems and methods described herein may be configured for improving security of payment devices. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. A payment device comprising:
a power source;
a processor in communication with the power source,
a memory in communication with the processor;
an input/output circuit in communication with the processor;
an input device in communication with the input/output circuit; and
an electronic display, in communication with the input/output circuit, that only displays sensitive data in response to actuation of the input device.

2. The payment device of claim 1, wherein the payment device comprises a plurality of layers comprising:
a substantially flat front surface;
a substantially flat back surface opposite the front surface; and
an inner region comprising openings for the processor, memory and power source.

3. The payment device of claim 2, wherein the substantially flat front surface further comprises a translucent region through which the display may be viewed.

4. The payment device of claim 2, wherein the substantially flat back surface further comprises a translucent region through which the display may be viewed.

5. The payment device of claim 1, wherein the input device comprises a heat sensitive region on the payment device, and wherein the processor is configured to detect warming of the heat sensitive region to determine that the input device has been actuated.

6. The payment device of claim 1, wherein the input device comprises a touch sensitive region on the payment device, and wherein the processor is configured to detect touching of the touch sensitive region to determine that the input device has been actuated.

7. The payment device of claim 1, wherein the input device comprises a motion sensor, and wherein the processor is configured to determine that a reading from the motion sensor meets or exceeds a threshold to determine that the input device has been actuated.

8. The payment device of claim 1, wherein the input device comprises an electronic signal receiver configured to receive an actuation signal from a device.

9. The payment device of claim 8, wherein the processor is configured to process the actuation signal to determine that the device is not trusted and to reset the payment device in response to receiving the actuation signal from the non-trusted device more than a threshold number of times during a period.

10. The payment device of claim 1, wherein the input device comprises a fingerprint reader adapted to detect fingerprints, and wherein the processor is configured to process a fingerprint input via the input device for determining whether the input fingerprint is associated with a trusted user.

11. The payment device of claim 1, wherein the input device comprises an image sensor configured to receive an input image, and wherein the processor performs an image analysis algorithm to process the input image for determining whether the input image is approved.

12. The payment device of claim 1, wherein the input device comprises an image sensor configured to receive an input image, and wherein the processor communicates the input image to a remote computing device executing an image analysis algorithm which reviews the input image and communicates an indication whether the input image is approved.

13. The payment device of claim 1, wherein the input device comprises a sound sensing device, wherein the processor is configured to apply a voice analysis algorithm to audio captured by the sound sensing device to determine if the captured audio includes a preset voice command.

14. The payment device of claim 1, wherein the input device comprises a sound sensing device, wherein the processor is configured to communicate a voice command captured by the sound sensing device to a remote computing device executing a voice analysis algorithm which reviews the recorded voice command and communicates an indication whether the recorded voice command is approved.

15. The payment device of claim 1, wherein the input/output circuit causes the electronic display to display first data in response to detecting input of a first sequence of inputs and second data in response to detecting input of a second sequence of inputs.

16. The payment device of claim 15, wherein the first data is at least one selected from a group consisting of: ccv, expiration date, card number, user name, issuer excluding the second data and
wherein the second data is selected from ccv, expiration date, card number, user name, issuer excluding the first data.

17. The payment device of claim 1, wherein the input/output circuit illuminates at least one of the input devices and a portion of the payment device, in response to detecting activation of the input device.

18. The payment device of claim 1, wherein the electronic display displays the sensitive data only for a given period of time.

19. The payment device of claim 1, wherein the input device is actuated to cause the electronic display to display a portion only a portion of the sensitive data at a time.

20. The payment device of claim 1, wherein the payment device comprises a plurality of displays arranged on the payment device, wherein the electronic display is configured to display the sensitive data in any of the plurality of displays and to rotate display of the sensitive data through the plurality of displays.
